(19) United States
(12) Patent Application Publication
(10) Pub. No.: US 2025/0326292 A1
(43) Pub. Date: Oct. 23, 2025

(54) DRIVE SYSTEM FOR A MOBILE WORK MACHINE

(71) Applicant: MANITOU BF, ANCENIS (FR)

(72) Inventor: David LEON, ANCENIS (FR)

(21) Appl. No.: 18/865,892

(22) PCT Filed: May 15, 2023
(86) PCT No.: PCT/EP2023/062964

§ 371 Date: Nov. 14, 2024

(30) Foreign Application Priority Data
May 31, 2022 (FR) FR2205247

(51) Int. Cl. B60K 17/356; B60K 1/02; B66F 9/075

(52) U.S. Cl. CPC B60K 17/356; B60K 1/02; B66F 9/07572; B60Y 2400/785

(57) ABSTRACT

The invention relates to a drive system (100) for a mobile work machine, the drive system (100) including a hydrostatic drive module including at least one hydrostatic pump (101) connected to at least one hydrostatic motor (102), the hydrostatic motor (102) being coupled to at least one driving wheel (5a) of the mobile work machine in order to rotate the at least one driving wheel (5a), and at least two electric motors (105, 106) for driving the hydrostatic pump (101), the two electric motors (105, 106) and the hydrostatic pump (101) being mounted in series on a common main shaft (104) for synchronous rotation thereof.

### TECHNICAL FIELD

The invention relates to the field of electric drive systems for mobile work machines.

### TECHNOLOGICAL BACKGROUND

Mobile work machines tend to be equipped with a drive system including an electric motor to limit emissions of polluting gas. The drive system may include a mechanical coupling between the motor and the driving wheels. In this case it is necessary to stop the electric motor and to reverse the direction of rotation of the electric motor to reverse the direction of movement of the work machine.

However, a hydrostatic drive system including at least a hydrostatic pump and a hydrostatic wheel motor makes it possible to generate a better traction force in the situation where the speed of movement of the work machine is low.

U.S. Pat. No. 10,578,211 discloses a utility vehicle for lifting persons including a hydrostatic drive system driving the axle, the vehicle including four wheels and being able to move forward and in reverse. The drive system described includes an electric motor driving two pumps, one for moving the vehicle and the other for actuating a lifting device, the electric motor and the two pumps being mounted in series on a common drive shaft.

However, a device of the above kind has limitations. In fact, the power delivered by the electric motor is limited and has to drive both pumps. Thus the force produced by the drive system is necessarily limited.

### SUMMARY

One idea behind the invention is to provide an electrically-driven mobile work machine that makes it possible to increase an available quantity of power for movement and where appropriate for actuating a lifting device.

One embodiment of the invention provides a drive system for a mobile work machine, the drive system including:
a hydrostatic drive module comprising at least one hydrostatic pump connected to at least one hydrostatic motor, the hydrostatic motor being coupled to at least one driving wheel of the mobile work machine to drive rotation of the at least one driving wheel, and
at least two electric motors for driving the hydrostatic pump,
   the two electric motors and the hydrostatic pump being mounted in series on a common main shaft to be driven in rotation synchronously.

Thanks to these features the drive system delivers a high hydrostatic traction force. Furthermore, a combination of at least two electric motors enables addition of the torques and the powers of the electric motors. Thus without increasing the electric current a total available torque and a total available power are higher. Maintaining a moderate current makes it possible to prevent harmful heating of the components of the drive system and therefore to extend the service life of the components.

Embodiments of a drive system of this kind may have one or more of the following features.

In one embodiment, the two electric motors are situated on respective opposite sides of the hydrostatic pump.

Thus forces on the common main shaft are better distributed so as to limit the force applied to each portion of the shaft and not to exceed acceptable mechanical stresses, thus preventing wear and a risk of malfunctioning of the drive system.

In one embodiment the drive system further includes a actuator hydraulic pump connected to at least one hydraulic actuator, said at least one hydraulic actuator being adapted to actuate a lifting arm of the mobile work machine, the actuator hydraulic pump being mounted in series on said common main shaft to be driven in rotation synchronously with the hydrostatic pump.

Thus said electric motor can drive the actuator hydraulic pump and the hydrostatic pump simultaneously while optimizing the distribution of the resisting torques generated by the two pumps, which limits the torques to be transmitted by each portion of the common main shaft.

Thus as the driving power for moving the lifting arm and the driving power for moving the mobile work machine are both generated by the rotation of the common main shaft, occasions to stop the rotation of the common main shaft during operation of the machine are reduced. This disposition therefore contributes to smoothing the operation of the electric motor or motors. Thus it is possible to reduce the number of stops and restarts of the electric motor or motors and the resulting drawbacks: high starting current, heating, intensive use reducing the service life of the electric components.

In one embodiment the actuator hydraulic pump is mounted directly in series with the hydrostatic pump.

In one embodiment two of said electric motors are situated on respective opposite sides of a combination of the hydrostatic pump and the actuator hydraulic pump mounted directly in series with the hydrostatic pump.

In one embodiment one of said electric motors is mounted between the actuator hydraulic pump and the hydrostatic pump.

In one embodiment the actuator hydraulic pump is a variable cubic capacity pump.

Thus the flowrate produced by the actuator hydraulic pump can vary as a function of a required speed of movement of the lifting arm.

In one embodiment the actuator hydraulic pump includes a plate with variable inclination.

In another embodiment the actuator hydraulic pump is a fixed cubic capacity pump, the drive system further including means for diverting a flow generated by the actuator hydraulic pump to a hydraulic fluid receiving tank in response to non-consumption of the flow generated, for example when the flowrate generated by the actuator hydraulic pump is greater than the required flowrate because of a regime of the electric motor greater than the requirement of the actuator hydraulic pump. The regime of the electric motor may be caused by a demand from other elements for other requirements, such as from the drive hydrostatic pump connected to the same main transmission shaft. The excess flow not used for hydraulic movements can be oriented toward the hydraulic fluid tank by a hydraulic distributor. Thus if the flowrate of the actuator hydraulic pump is not used it can be diverted toward the hydraulic fluid receiving tank.

In one embodiment the drive system further includes a control unit, the control unit including an operator interface, the control unit being configured to start rotation of the common main shaft in response to receiving via the operator interface an instruction to raise the lifting arm or an instruction to move the mobile work machine.

Thus an operator will be able to control the drive system by sending a signal for raising the arm, a signal for lowering the arm or a signal for moving the mobile work machine.

In one embodiment the rotation of the common main shaft stops after a latency time during which no instruction to raise the lifting arm or to move the mobile work machine is received via the operator interface.

Thus the number of times the electric motors are started is reduced, making it possible to preserve the inertia of the drive system. Furthermore, a reduction in the number of times the electric motors are started makes it possible to optimize the service life of the electric motors and the inverters, the electric motors and the inverters deteriorating if they are subjected too frequently to otherwise high starting currents.

In one embodiment the electric motors are able to generate a total driving power and the control unit enables variation of the distribution of the total driving power between a partial driving power allocated to the moving the mobile work machine and a partial driving power allocated to actuating the lifting arm. The control unit may have its parameters set in the factory or be configured by the user. For configuration by the user an appropriate human-machine interface may be provided in the control station and can take other forms: for example a dedicated menu of a graphical user interface, a knob with at least two positions, a potentiometer type knob, and more generally any other control device made available to the user to act on the distribution of power.

Thus the power generated by the hydrostatic pump and the actuator hydraulic pump will be adjusted by the control unit as a function of the pressure and flowrate required.

In one embodiment the control unit causes said distribution of the total driving power to be varied in response to a distribution request received via the operator interface.

Thus in one operating mode operators can vary for themselves the use of the available driving power by influencing the distribution between the power allocated to moving the work machine and the power allocated to actuating the lifting arm.

In one embodiment the drive system further includes a third electric motor mounted in series on said common main shaft.

Thus an available quantity of power may be increased and/or lower currents may be used to generate the same power.

In one embodiment at least two electric motors are mounted directly in series.

In one embodiment the common main shaft is formed by shaft segments coupled in rotation to one another by coupling devices.

Thus the length of the common main shaft can be adapted to suit additional pumps and additional motors that may be added to the drive system. Furthermore, different components of the drive system rotate synchronously.

In one embodiment said coupling device is a device with splines.

In one embodiment the hydrostatic pump and/or one of said electric motors include(s) a through-shaft forming one of said shaft segments, said through-shaft having two ends provided with respective coupling devices.

Thus the various components of the drive system may be mounted in series to form the common main shaft.

In one embodiment the hydrostatic pump includes a main mount and an auxiliary mount, the main mount being disposed on a first side of the hydrostatic pump that the common main shaft passes through and the auxiliary mount being disposed on a second side of the hydrostatic pump that the common main shaft also passes through, the second side of the hydrostatic pump being opposite the first side.

Thus the electric motors can easily be mounted on each side of the hydrostatic pump.

In one embodiment the hydrostatic pump is a reversible flow pump including a control member that can be actuated to reverse the direction of flow of the fluid between the hydrostatic pump and the hydrostatic motor without changing the direction of rotation of the common main shaft.

Thus the direction of circulation of the fluid can be reversed, enabling a direction of movement of the mobile working machine also to be reversed.

Thus it is not necessary to change the direction of rotation of the common main shaft and/or of the electric motors.

Thus an inertia of the drive system is preserved on changing the direction of movement of the mobile work machine.

In one embodiment the hydrostatic pump is a variable cubic capacity pump.

Thus the hydraulic power at the output of the hydrostatic pump is able to vary as a function of a required force and speed of movement of the mobile work machine.

In one embodiment the hydrostatic pump includes a plate with variable inclination.

In one embodiment the control unit is configured to control a cubic capacity of the hydrostatic pump and/or a cubic capacity of the actuator hydraulic pump.

In one embodiment the drive system further includes an actuator hydraulic pump connected to at least one hydraulic actuator, said at least one hydraulic actuator being adapted to actuate a lifting arm of the work machine, the actuator hydraulic pump not being mounted in series on said common main shaft, and a secondary electric motor for driving the actuator hydraulic pump independently of the hydrostatic pump.

Thus the actuator hydraulic pump and the hydrostatic pump can be decoupled.

In one embodiment the drive system further includes a flywheel coupled to the common main shaft.

Thus the flywheel makes it possible to store energy produced during the latency period and to restore it afterwards.

In one embodiment the drive hydrostatic module includes a plurality of hydrostatic pumps, for example two or four hydrostatic pumps, mounted in series on the common main shaft for synchronous rotation thereof. In embodiments the features indicated hereinabove related to the hydrostatic pump may be applied to one or to each of said hydrostatic pumps.

### BRIEF DESCRIPTION OF THE FIGURES

The invention will be better understood and other aims, details, features and advantages thereof will become more clearly apparent in the course of the following description of particular embodiments of the invention given by way of non-limiting illustration only with reference to the appended drawings.

FIG. 1 is a representation from the side of an electrically-driven front loader including a lifting arm.

FIG. 2 is a schematic representation of a first embodiment of a drive system of the electrically-driven front loader from FIG. 1.

FIG. 3 is a representation in section of an electric motor that can be used in a preferred embodiment of the drive system.

FIG. 4 is a representation in section of a hydrostatic pump that can be used in the preferred embodiment of the drive system.

FIG. 5 is a schematic representation of a second embodiment of the drive system.

FIG. 6 is a perspective view of a third embodiment of the drive system.

FIG. 7 is a schematic representation of the third embodiment of the drive system.

FIG. 8 is a schematic representation of a fourth embodiment of the drive system.

FIG. 9 is a schematic representation of a fifth embodiment of the drive system.

FIG. 10 is a schematic representation of a sixth embodiment of the drive system.

### DESCRIPTION OF EMBODIMENTS

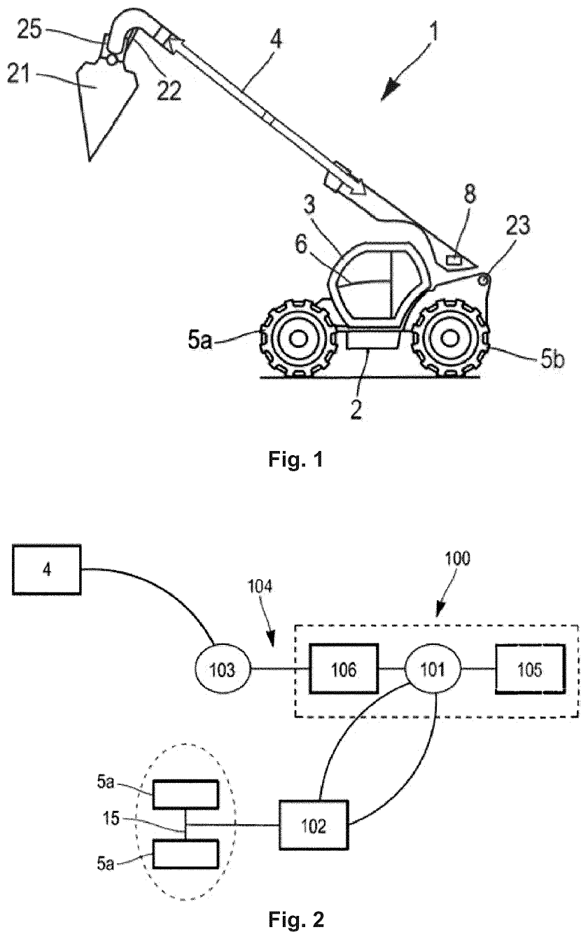

FIG. 1 represents an electrically-driven front loader 1 including a main body 2 mounted on a front axle 15 including two front wheels 5a and a rear axle 16 including two rear wheels 5b. A lifting arm 4, represented here in a raised position, is mounted to pivot about a horizontal axis at the rear of the main body 2. On top of the main body 2 is a driver's cab 3 in which an operator can take their place to drive the front loader 1 and to control actuation of the lifting arm 4.

The lifting arm 4 may be a telescopic arm adjustable in length between a retracted position and a deployed position. The lifting arm enables carrying of loads. A degree of freedom in rotation between the main body 2 and the lifting arm 4 enables the lifting arm 4 to be raised or lowered by means of a lifting cylinder that is not represented. A tool 21 may fixed to a toolholder 25 of the lifting arm 4. In a preferred embodiment the toolholder 25 may be designed for removably mounting various tools such as forks, a jib, a bucket or other tools. A digging cylinder 22 enables orientation of the tool 21 relative to the lifting arm 4. A telescoping cylinder that is not represented enables adjustment of the length of the telescopic arm.

Driving movement of the front loader 1 is enabled by rotating the front wheels 5a in contact with the ground by means of a hydrostatic transmission system. A hydraulic movement driving device enables actuation of the lifting arm 4. The hydrostatic transmission system and the hydraulic movement driving device are parts of a drive system that will be described with reference to FIGS. 2 to 10.

There will be described with reference to FIGS. 2 to 10 the structure and the operation of a drive system for driving movement of the front loader 1 and movement of the lifting arm.

Referring to FIGS. 2 to 4, a main transmission shaft 104 is common to two electric motors 105 and 106, a hydrostatic main pump 101 and a hydraulic secondary pump 103. The two electric motors 105 and 106 consist of an end electric motor 105 and an intermediate position electric motor 106. The reference number 100 identifies more precisely the elements constituting the hydrostatic transmission system.

The main transmission shaft 104 may be formed by joining constituent segments of the shaft specific to each component: the end electric motor 105, the hydrostatic main pump 101, the intermediate position electric motor 106 and the hydraulic secondary pump 103. These segments can be interconnected by splined couplings. Multiple dimensions are possible for the splined couplings of the main transmission shaft 104 so as to increase compatibility between different parts.

The end electric motor 105, the intermediate position electric motor 106, the hydrostatic main pump 101 and the hydraulic secondary pump 103 each include a transmission shaft section, the ends of the transmission shaft section possibly being provided with recessed (female) splined connections or solid (male) splined connections to facilitate nesting with another transmission shaft section. The main transmission shaft 104 consists of interleaved transmission shaft sections.

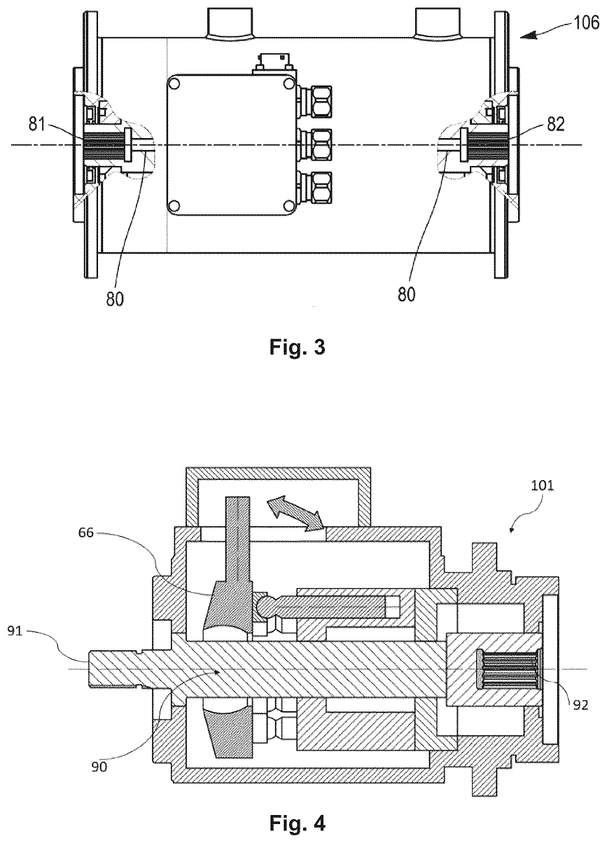

Referring to FIG. 3, the intermediate position electric motor 106 is represented. The shaft 80 of the intermediate position electric motor 106 includes two recessed splined connections 81 and 82.

Referring to FIG. 2, the intermediate position electric motor 106 is mounted in series between the hydrostatic main pump 101 and the hydraulic secondary pump 103.

Referring to FIG. 4, the hydrostatic main pump 101 includes a main coupling 91 and a secondary coupling 92, the main coupling 91 and the secondary coupling 92 being located at two opposite ends of the shaft 90 of the hydrostatic main pump 101. Here the main coupling 91 is a male splined connection and the secondary coupling 92 is a female splined connection.

The main coupling 91 and the secondary coupling 92 respectively enable mounting of the intermediate position electric motor 106 on one side and the end electric motor 105 on the other side, the end electric motor and the intermediate position electric motor 106 driving the hydrostatic main pump 101.

The hydrostatic main pump 101 includes a plate 66 with adjustable inclination enabling variation of the cubic capacity of the pump.

Referring to FIG. 2, the hydrostatic main pump 101 exchanges an incompressible fluid with at least one hydrostatic motor 102 that drives the driving wheels of the front loader 1 in rotation. The driving wheels are for example the front wheels 5a, 5b (i.e. two driving wheels) or the front wheels 5a and the rear wheels 5b (i.e. four driving wheels). A plurality of hydrostatic motors may be provided for this purpose. In this respect FIG. 2 is schematic.

The hydraulic secondary pump 103 feeds the actuators of the lifting arm 4.

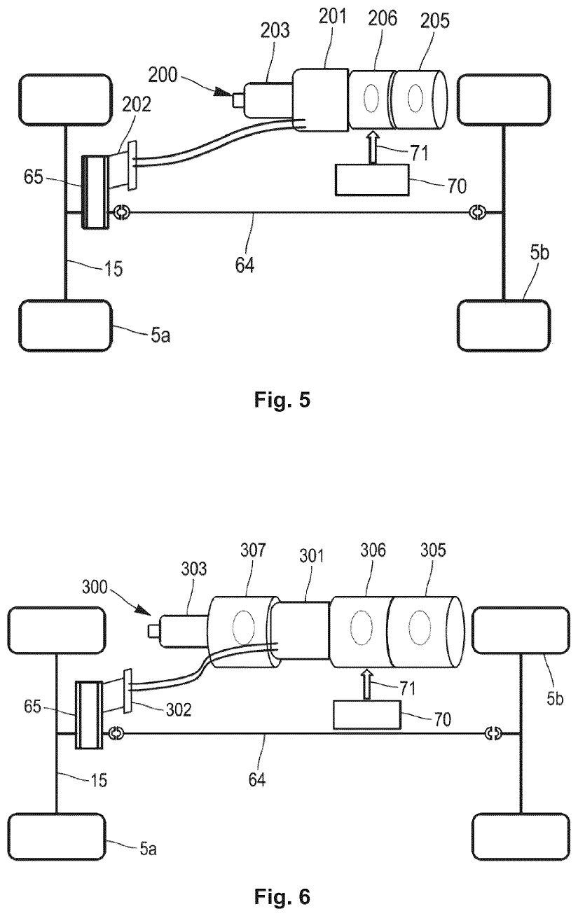

A second embodiment of a drive system 200 is described with reference to FIG. 5. An end electric motor 205 is mounted in series with an intermediate position electric motor 206. A hydrostatic main pump 201 is mounted in series with the intermediate position electric motor 206 and a hydraulic second pump 203, the hydrostatic main pump 201 exchanging a fluid with at least one hydrostatic motor 202 driving the front wheels 5a of the front loader 1 via a reducer gearbox 65. Here a transmission shaft 64 couples the reducer gearbox 65 to the rear axle as well so as to be able to employ four driving wheels.

The hydraulic secondary pump 203 feeds the actuators of the lifting arm 4.

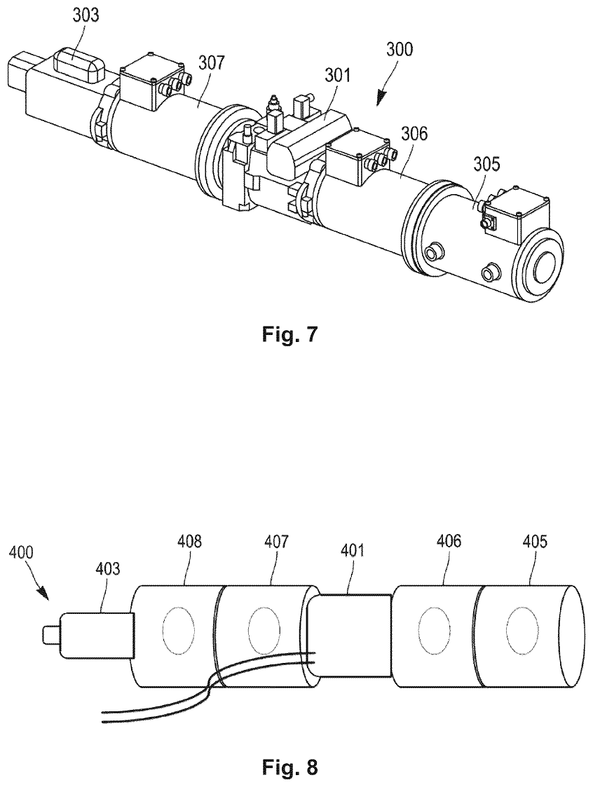

A third embodiment of a drive system 300 is described with reference to FIGS. 6 and 7. An end electric motor 305 is mounted in series with a first intermediate position electric motor 306 on a main transmission shaft.

The first intermediate position electric motor 306 is mounted in series with a hydrostatic main pump 301, the hydrostatic main pump 301 being also mounted in series with a second intermediate position electric motor 307. The second intermediate position electric motor 307 is mounted in series with a hydraulic secondary pump 303.

A fourth embodiment of a drive system 400 is described with reference to FIG. 8. An end electric motor 405 is mounted in series with a first intermediate position electric motor 406, the first intermediate position electric motor 406 being mounted in series with the hydrostatic main pump 401. The hydrostatic main pump 401 is moreover mounted in series with a second intermediate position electric motor 407.

The second intermediate position electric motor 407 is coupled to a third intermediate position electric motor 408, the third intermediate position motor 408 being moreover mounted in series with a hydraulic secondary pump 403.

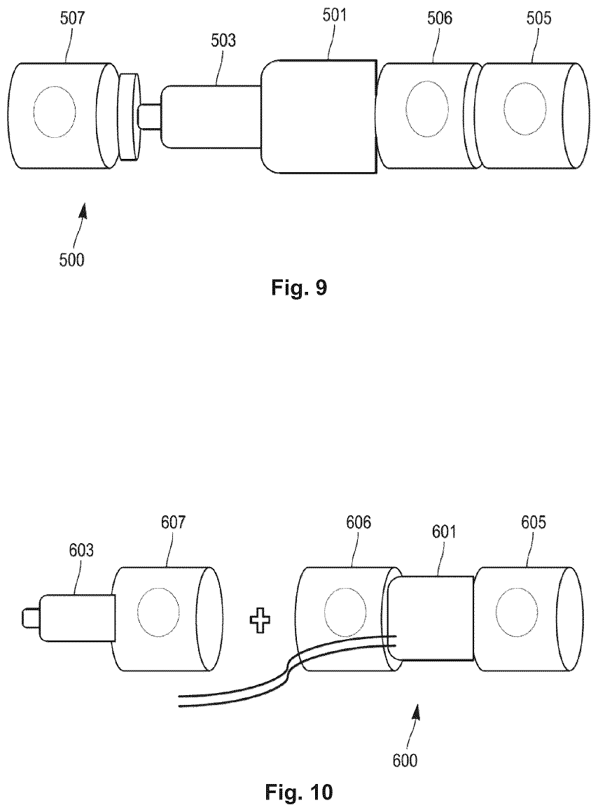

A fifth embodiment of a drive system 500 is described with reference to FIG. 9. A first end electric motor 505 is mounted in series with an intermediate position electric motor 506, the intermediate position electric motor 506 being mounted in series with a hydrostatic main pump 501.

The hydrostatic main pump 501 is mounted directly in series with a hydraulic secondary pump 503. The hydraulic secondary pump 503 is moreover mounted in series with a second end electric motor 507.

A sixth embodiment of a hydrostatic transmission system 600 is described with reference to FIG. 10. A first end electric motor 605 is mounted in series with a hydrostatic main pump 601, the hydrostatic main pump 601 being also mounted in series with a second end electric motor 606. The first end electric motor 605, the hydrostatic main pump 601 and the second end electric motor 606 are mounted on a main transmission shaft.

The drive system further includes a third motor 607 mounted in series with the hydraulic secondary pump 603; they are independent of the hydrostatic transmission system 600.

It is clear that other embodiments not explicitly described may be envisaged. In particular, the number of electric motors and the positions of said electric motors in a hydrostatic transmission system may be varied. Furthermore, other hydraulic secondary pumps of fixed cubic capacity or variable cubic capacity and/or hydrostatic secondary pumps may be added.

Furthermore, compressors and speed reducers may be included in the hydrostatic transmission system.

The operation of the systems represented will now be described with reference to FIGS. 2 to 10.

On the main transmission shaft at least two electric motors drive in rotation at least one hydrostatic main pump and possibly a hydraulic secondary pump.

Referring to FIG. 2, the hydrostatic main pump 101 is driven in rotation synchronously by the first end electric motor 105 and the intermediate position electric motor 106. The hydraulic secondary pump 103 is also driven in rotation synchronously by the first end electric motor 105 and the intermediate position electric motor 106 about the main transmission shaft 104.

In other words the hydrostatic main pump 101 is driven in rotation by electric motors 105 and 106 mounted in series on respective opposite sides of the hydrostatic main pump 101, the electric motors rotating synchronously because of the coupling of the shaft segments to one another.

Referring to FIG. 5, the hydrostatic pump 201 is driven in rotation by a combination consisting of the end electric motor 205 and the intermediate position electric motor 206. The hydraulic secondary pump 203 is mounted in series with the hydrostatic main pump 201 on the main transmission shaft (not represented) and is driven in rotation synchronously with the hydrostatic main pump 201.

Referring to FIGS. 6 and 7, the hydrostatic main pump 301 is driven in rotation on the one hand by a combination consisting of the end electric motor 305 and the first intermediate electric motor 306 and on the other hand by the second intermediate position electric motor 307, the end electric motor 305, the first intermediate position electric motor 306 and the second intermediate position electric motor 307 rotating synchronously because of the coupling of the shaft segments with one another.

Referring to FIG. 8, the hydrostatic main pump 401 is driven in rotation on the one hand by a first combination consisting of the end electric motor 405 and the first intermediate position electric motor 406 and on the other hand by a second combination consisting of the second intermediate position electric motor 407 and the third intermediate position electric motor 408.

Referring to FIG. 9, a combination of motors consisting of the first end electric motor 505 and the intermediate position electric motor 506 rotates synchronously with the second end electric motor 507, and the hydrostatic main pump 501 and the hydraulic secondary pump 503 are driven synchronously by said combination of motors and the second end electric motor 507.

Referring to FIG. 10, the secondary transmission shaft and the main transmission shaft are distinct and do not turn synchronously. Thus electric motors 605 and 606 on the main transmission shaft can have different rotation speeds than those of the electric motor 607 situated on the secondary transmission shaft.

Referring to FIGS. 6 and 7, a control unit 70 communicates with the transmission system to transmit a set point 71, the set point possibly being a set point for movement of the front loader 1 or a set point for movement of the lifting arm.

Furthermore, the control unit varies the power produced by the hydrostatic main pump 101-601 and the power produced by the hydraulic secondary pump 103-603. In particular, an operator interface may be used by an operator driving the front loader 1 to choose the power produced by the hydrostatic main pump 101-601 and the power produced by the hydraulic secondary pump 103-603.

The power produced by the hydrostatic main pump 101-601 is adjusted by modification of the cubic capacity of the hydrostatic main pump 101-601. In a preferred embodiment the power produced by the hydrostatic main pump 101-601 is adjusted by modification of the angle of inclination of an oscillating plate of the hydrostatic main pump 101-601.

The power produced by the hydraulic secondary pump 103-603 is adjusted by modifying the cubic capacity of the hydraulic secondary pump 103-603. In a preferred embodiment the power produced by the hydraulic second pump 103-603 is adjusted by modifying the angle of inclination of an oscillating plate of the hydraulic secondary pump.

In particular the available power can be entirely allocated to the hydraulic secondary pump 103-603. In fact, if the front loader 1 is immobile and the lifting arm is moving, the oscillating plate of the hydrostatic main pump 101-601 may be set to a minimum or zero cubic capacity so that no torque is produced by the hydrostatic main pump 101-601. Likewise, all the torque available may be allocated to the hydrostatic main pump 101-601 by setting to the minimum or zero cubic capacity the oscillating plate of the hydraulic secondary pump 103-603.

The inclination of the oscillating plate of the hydrostatic main pump 101-601 and the inclination of the oscillating plate of the hydraulic secondary pump 103-603 may be modified by the control unit either automatically or by the operator via the operator interface.

Thus the main transmission shaft continues to turn in the situation where the front loader 1 is not moving or in the situation where the lifting arm 4 is immobile.

If the main transmission shaft 104 is stopped, the control unit can send a start signal to the hydrostatic transmission system 100-600. The start signal is generated when an instruction to move the front loader 1 or an instruction to move the lifting arm 4 is transmitted via the operator interface. The start signal initiates rotation of the main transmission shaft 104.

A waiting regime is introduced in a situation in which the front loader 1 is stopped and the lifting arm 4 is immobile. For the main transmission shaft 104 the waiting regime consists in it continuing to turn for a predefined latency time which in a preferred embodiment may be thirty seconds.

If the latency time elapses and no new instruction for moving the lifting arm 4 or a new instruction for moving the front loader 1 is transmitted to the hydrostatic transmission system 100-600 the main transmission shaft 104 then stops turning.

The latency time enables prevention of untimely stopping of the electric motors and thus the momentum of the hydrostatic transmission system 100-600 can be preserved. On the other hand the motors may be stopped in the situation of an instruction to stop transmitted by the operator or by detection of a specific action. For example, unfastening a safety belt may result in automatic stopping of the motors.

In one embodiment the hydrostatic transmission system includes a flywheel which may be of fixed or variable momentum. During the latency time the power produced by the hydrostatic main pump 101-601 and the power produced by the hydraulic secondary pump 103-603 are zero but the main transmission shaft continues to turn. Thus the flywheel is charged and stores kinetic energy produced by the electric motors.

If the latency time is interrupted and movement of the lifting arm or movement of the front loader 1 resumes, the flywheel can then restore stored energy.

The momentum of the hydrostatic transmission system 100-600 may furthermore be preserved if the front loader 1 changes its direction of movement from forward movement to reverse movement or from reverse movement to forward movement.

In a preferred embodiment the electric motors can turn in only one direction. Thus the main transmission shaft 104 also has only one direction of rotation.

In a configuration of this kind the direction of movement of the front loader 1 is changed by means of a change in the direction of circulation of the fluid in the hydrostatic main pump 101-601 and in the hydrostatic motor 102-602. The fluid circulating in the opposite direction causes rotation of the wheels 5 in the opposite direction.

In one embodiment adjusting the inclination of the oscillating plate enables reversing of the direction of circulation of the fluid.

The speed of movement of the front loader 1 is preferably between 0 and 35 km/h inclusive.

The main transmission shaft 104 preferably rotates at a rotation speed corresponding to a nominal regime of the electric motors.

Although the invention has been described in connection with a plurality of particular embodiments, it is obvious that it is in no way limited to them and that it encompasses all technical equivalents and combinations of the means described if the latter fall within the scope of the invention.

The use of the verb “to include” or “to comprise” and conjugate forms thereof does not exclude the presence of elements or steps other than those stated in a claim. The use of the indefinite article “a” or “an” for an element or a step does not exclude the presence of a plurality of such elements or steps unless otherwise specified.

In the claims, any reference sign between parentheses should not be interpreted as a limitation of the claim.

1. A drive system (100-600) for a mobile work machine (1), the drive system including:
a hydrostatic drive module comprising a hydrostatic pump (101-601) connected to at least one hydrostatic motor (102-602), the hydrostatic motor being coupled to at least one driving wheel (5a) of the mobile work machine (1) to drive rotation of the at least one driving wheel (5a), and
two electric motors (105-605, 106-606) for driving the hydrostatic pump (101-601), the two electric motors (105-605, 106-606) and the hydrostatic pump (101-601) being mounted in series on a common main shaft (104) to be driven in rotation synchronously.

2. The drive system (100-600) as claimed in claim 1, in which the two electric motors (105-605, 106-606) are situated on respective opposite sides of the hydrostatic pump (101-601).

3. The drive system (100-600) as claimed in claim 1 or 2 further including an actuator hydraulic pump (103-603) connected to at least one hydraulic actuator, said at least one hydraulic actuator being adapted to actuate a lifting arm (4) of the mobile work machine (1), the actuator hydraulic pump being mounted in series on said common main shaft (104) to be driven in rotation synchronously with the hydrostatic pump (101-601).

4. The drive system (100-600) as claimed in claim 3 in which the actuator hydraulic pump (103-603) is mounted directly in series with the hydrostatic pump (101-601).

5. The drive system (500) as claimed in claim 4 in which two electric motors (506, 507) are situated on respective opposite sides of a combination of the hydrostatic pump (501) and the actuator hydraulic pump (503) mounted directly in series with the hydrostatic pump (501).

6. The drive system (300) as claimed in claim 3 in which an electric motor (307) is mounted between the actuator hydraulic pump (303) and the hydrostatic pump (301).

7. The drive system as claimed in any one of claims 3 to 6 in which the actuator hydraulic pump (103-603) is a variable cubic capacity pump.

8. The drive system as claimed in any one of claims 3 to 6 in which the actuator hydraulic pump (103-603) is a fixed cubic capacity pump, the drive system further including means for diverting a flow generated by the actuator hydraulic pump (103-603) to a hydraulic fluid receiving tank in response to non-consumption of the flow generated.

9. The drive system (100-600) as claimed in any one of claims 3 to 8 further including a control unit, the control unit including an operator interface, the control unit being configured to start rotation of the common main shaft (104) in response to receiving via the operator interface an instruction to raise the lifting arm (4) or an instruction to move the mobile work machine (1).

10. The drive system (100-600) as claimed in claim 9 in which the rotation of the common main shaft (104) stops after a latency time during which no instruction to raise the lifting arm (4) or to move the mobile work machine (1) is received by the operator interface.

11. The drive system (100-600) as claimed in any one of the preceding claims in which the common main shaft (104) is formed by shaft segments rotationally coupled to one another by coupling devices.

12. The drive system (100-600) as claimed in claim 11 in which said coupling devices are splined devices.

13. The drive system (100-600) as claimed in claim 11 or 12 in which the hydrostatic pump (101-601) and/or an electric motor (105-605, 106-606) includes a through-shaft forming a shaft segment, said through-shaft having two ends provided with respective coupling devices.

14. The drive system (100-600) as claimed in any one of the preceding claims in which the hydrostatic pump (101-601) is a reversible flow pump including a control member that can be actuated to reverse the direction of flow of the fluid between the hydrostatic pump (101-601) and the hydrostatic motor (102-602) without changing the direction of rotation of the common main shaft (104).

15. The drive system (100-600) as claimed in any one of the preceding claims in which the hydrostatic pump (101-601) is a variable cubic capacity pump.

16. The drive system (100-600) as claimed in any one of the preceding claims further including a flywheel coupled to the common main shaft (104).
